(19) United States
(12) Patent Application Publication
(10) Pub. No.: US 2014/0009104 A1
(43) Pub. Date: Jan. 9, 2014

(54) AC Solar Panel System

(71) Applicants: Mehmet Bahattin Daloglu, Ankara (TR); Mehmet Izzet Ozaydin, Ankara (TR)

(72) Inventors: Mehmet Bahattin Daloglu, Ankara (TR); Mehmet Izzet Ozaydin, Ankara (TR)

(73) Assignee: SUNGLEGO ENERJI SISTEMLERI SANAYI VE TICARET ANONIM SIRKETI, Ankara (TR)

(21) Appl. No.: 13/997,178

(22) PCT Filed: Jul. 26, 2012
(86) PCT No.: PCT/IB12/53823

§ 371 Date: Jun. 21, 2013

(30) Foreign Application Priority Data
Jul. 3, 2012 (TR) TR 2012/07747

(51) Int. Cl. H02J 3/00; H02J 7/35; H02J 7/02

(52) U.S. Cl. CPC H02J 3/00; H02J 7/025; H02J 7/35
USPC 320/101; 307/82

(57) ABSTRACT

The present invention relates to an AC solar panel system (1) which converts solar energy into electrical energy and provides alternating current as output. The inventive AC solar panel system (1) comprises: a photovoltaic panel (4) which converts solar energy into direct current electricity, a frame (7) which encloses the photovoltaic panel (4) safely, and a direct current-alternating current inverter (8) which is placed into the frame (7) and converts the direct current that is generated by the photovoltaic panel (4) into alternating current. In the event that it is also desired to store the energy generated, a plurality of batteries (10) are connected to the photovoltaic panel (4) which has the inverter (8) together with the charge control member (11) and into the frame (7) electrically.

### TECHNICAL FIELD

The present invention relates to a solar generator system which converts solar energy into electrical energy, can store energy on itself as well and provides alternating current (AC) directly as output.

### BACKGROUND OF THE INVENTION

Today, renewable energy sources such as river, wave, biomass, geothermal, solar and hydrogen energy have started gaining great importance upon fossil fuel sources started run out. Solar energy is one of the most commonly used one of the said renewable energy sources. Electrical energy is obtained from solar energy by means of solar panels.

Solar panels basically have a structure which consists of uniting a plurality of photovoltaic cells together on a carrier table under glass and combining edges by frame. The said photovoltaic cells convert energy in solar rays into direct current (DC). However, due to the fact that the said direct current cannot be sent to electricity network it is used by being crossed over an inverter which converts the direct current into alternating current in solar panel output. The said inverter converts the electricity, which is generated by the solar panel, into alternating current and gives it to the electricity network.

A large number of solar panels are united together and they are connected in series or in parallel. The direct current formed is then sent to a common direct current-alternating current inverter and converted into alternating current. Selection of the said inverter plays an essential role in system efficiency. In the system, energy-generating capacity of the system decreases prominently in the event that an unsuitable wrong inverter is used. In addition, in the event that any of a plurality of panels connected in series generates voltage less than others due to it is shading or broken-down, because the dominant voltage in the inverter is the lowest voltage the system generates less energy than expected in many installations. Further, expert support is required in order to make technical selection of the inverter which is separate from the panel and to mount it. And this leads to increase of mounting cost and the first installation cost of the system increases.

Due to these reasons, use of micro inverters has started to increase recently. Micro inverters are generally manufactured in a power capacity equivalent to each photovoltaic panel. To the panel that is received one by one, the micro inverter is mounted to a suitable part of the panel using one of methods of screwing, sliding-locking on the channel or bonding behind the panel or any of the four edges of the panel frame in the field or at the end of panel production line. In the event that the inverter is mounted in the field, total installation time of the systems extends.

The International patent document no. WO2009/143253 discloses alternating current photovoltaic panels which has a direct current-alternating current inverter that collects less heat, can operate under relatively cool conditions. The said photovoltaic panels comprise a direct current photovoltaic module and a direct current-alternating current inverter. The direct current photovoltaic module converts solar energy into direct current whereas the inverter converts the direct current into alternating current. In the invention which is described in the International patent document no. WO2009/143253, the inverter is mounted out of the frame holding the panel after completion of panel production. In the said patent document no. WO2009/143253, the photovoltaic panel and the inverter are manufactured in separate boxes and they are combined later and both units are in a separate frame or box.

### SUMMARY OF THE INVENTION

An objective of the present invention is to realize an AC solar panel system which provides alternating current directly as output.

Another objective of the present invention is to realize an AC solar panel system which enables to reduce period and cost of assembly.

Another objective of the present invention is to realize an AC solar panel system which enables to meet need for electricity from sun easily in places where there is no electricity network (off-grid areas).

Another objective of the present invention is to realize an AC solar panel system which can be transported to places where there is no electricity network (off-grid areas) easily and enables to meet need for electricity in these places.

Another objective of the present invention is to realize an AC solar panel system which generates alternating current (AC) directly, can store suitable energy on itself, ready for mounting and use.

Another objective of the present invention is to realize an AC solar panel system which can be operated by persons with no expertise only by plug-in process and utilizable at voltage of 220 V directly in the day and night time.

Another objective of the present invention is to realize an AC solar panel system which can be transported as a whole, in which there is charge control unit, batteries and inverter, energizes the system at desired voltage in alternating current directly when it is plugged in.

### DESCRIPTION OF THE INVENTION

“An AC Solar Panel System” realized to fulfill the objectives of the present invention is shown in the figures attached, in which:

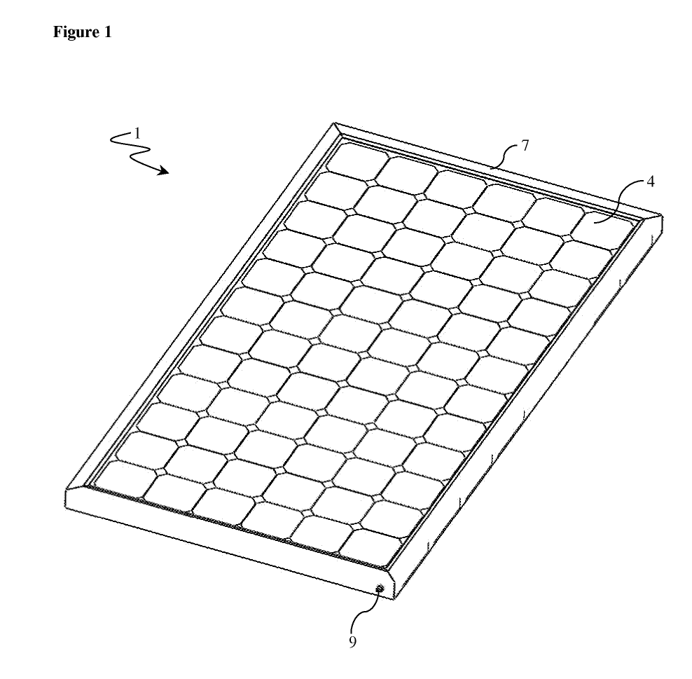

FIG. 1 is a perspective view of the inventive solar panel system.

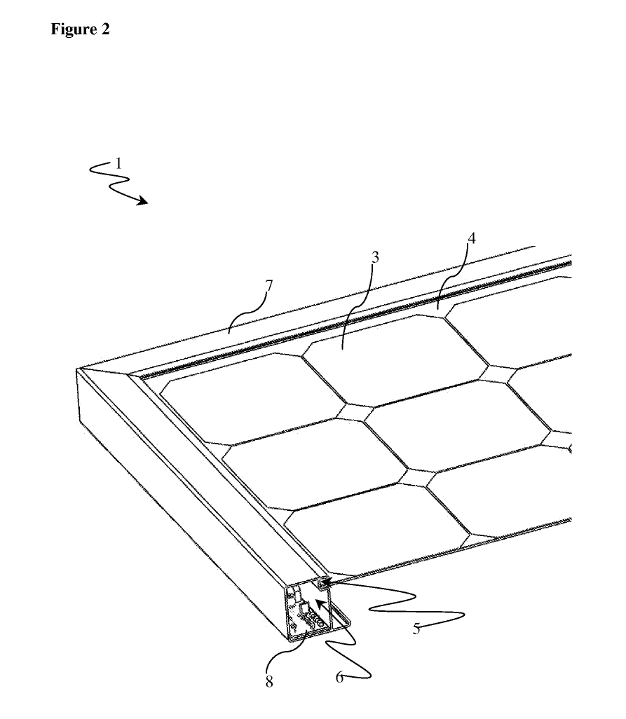

FIG. 2 is a sectional view of the inventive solar panel system.

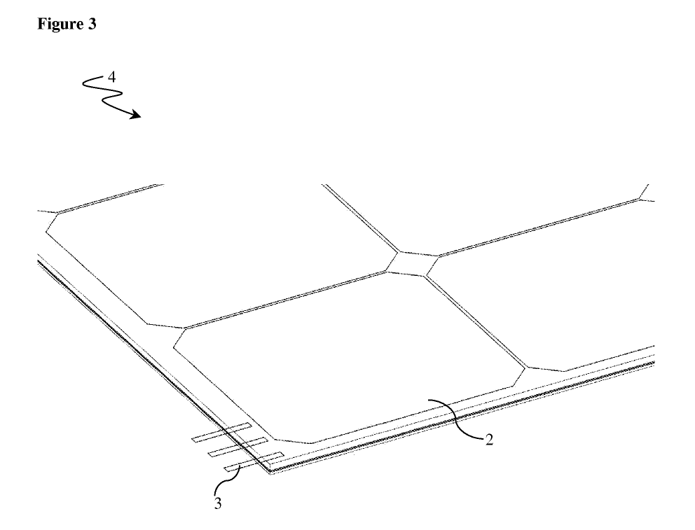

FIG. 3 is a detailed view of the photovoltaic panel provided in the inventive solar panel system.

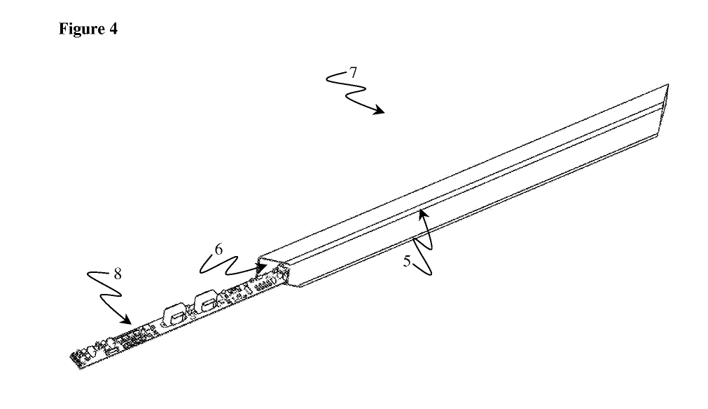

FIG. 4 is a detailed view of the frame provided in the inventive solar panel system.

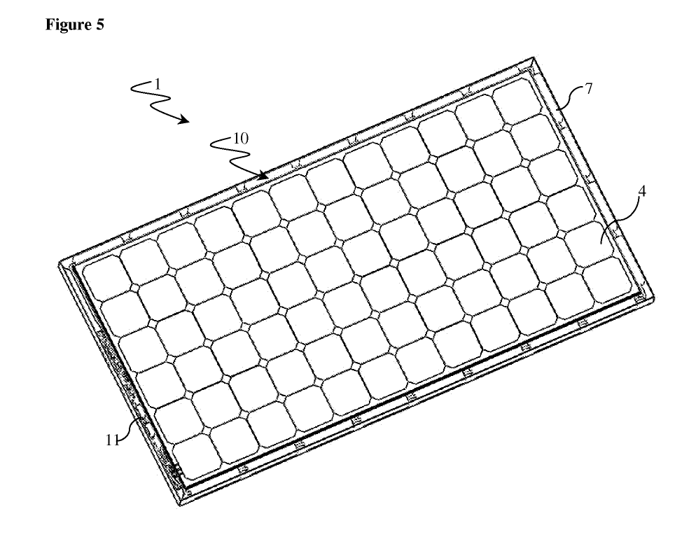

FIG. 5 is a perspective view of an embodiment of the inventive solar panel system.

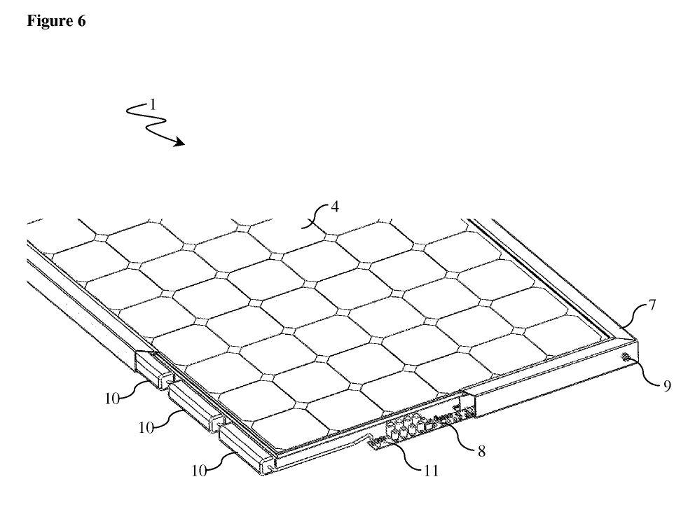

FIG. 6 is a sectional view of an embodiment of the inventive solar panel system.

The components illustrated in the figures are individually numbered, where the numbers refer to the following:

1. AC solar panel system

2. Cell

3. Connector

4. Photovoltaic panel

5. Channel

6. Chamber

7. Frame

8. Direct current-alternating current inverter

9. Plug

10. Battery

11. Charge control circuit

The inventive AC solar panel system (1) comprises:
at least one photovoltaic panel (4) which has a plurality of cells (2) that convert energy in sun ray into direct current electricity and at least one connector (3) that enables current to go out on thereof;
at least one frame (7) which encloses the photovoltaic panel (4), has a channel (5) that enables the photovoltaic panel (4) to be hold safely at the surface thereof facing the photovoltaic panel (4) and an empty chamber (6) in itself;
at least one direct current-alternating current inverter (8) which is placed into the chamber (6) that is provided in the frame (7), connected to the connector (3) and converts the direct current that is received from the connector (3) into alternating current.

On the frame (7) which is provided in the inventive AC solar panel system (1), there is at least one plug (9) associated with the direct current-alternating current inverter (8) which enables the alternating current that is formed by the direct current-alternating current inverter (8) to be fed to systems outside the panel (1). Electricity network line or device to be used can be directly connected to the said plug (9).

In the inventive AC solar panel system (1), the cells (2) which are located on the photovoltaic panel (4) convert solar energy into direct current electricity. The said direct current electricity is transmitted from the connector (3) to the direct current-alternating current inverter (8). And the direct current-alternating current inverter (8) enables to give alternating current from the solar panel (1) directly by converting the direct current received from the connector (3) into alternating current. Thus, after buying the solar panel, the user does not need to select a direct current-alternating current inverter (8) separately and mount this to the panel after s/he buys the AC solar panel system (1).

In the preferred embodiment of the invention, the channel (5) which is located on the frame (7) and in which the photovoltaic panel (4) is placed has a C form.

In the preferred embodiment of the invention, the photovoltaic panel (4) has a rectangular shape. In this embodiment, the AC solar panel system (1) comprises four frames (7) independent of each other which are identical in form and enable to hold the said photovoltaic panel (4) from each edge thereof safely. In this embodiment, the direct current-alternating current inverter (8) is placed into the chamber (6) which is located in the frame (7) that is closest to the connector (3) provided in the photovoltaic panel (4).

In an embodiment of the invention, the AC solar panel system (1) comprises at least one battery (10) which is located in the chamber provided in the frame (7), and connected to the direct current-alternating current inverter (8) electrically from one end thereof and to the photovoltaic panel (4) from the other end thereof, and enables to store the direct current generated by the cells (2). The said battery (10) enables systems which are connected to the solar panel system (1) to be fed at night or in times when solar rays are insufficient such as cloudy weather. In the said embodiment, the AC solar panel system (1) also comprises at least one charge control circuit (11) which is placed into the chamber (6) provided in the frame (7) and enables the battery (10) to be charged in a controlled manner by regulating the voltage of the photovoltaic panel (4), and connected to the battery (10) electrically from one end thereof. By controlling charge-discharge states of the battery (10), the charge control circuit (11) prevents it from being charged and discharged excessively that prolongs the battery (10) life. With this embodiment of the invention, the user can easily obtain electricity in rural areas where there is no electricity network for a long time and use electrically operated devices.

In an embodiment of the invention, the AC solar panel system (1) comprises a plurality of batteries (10) which are connected to each other electrically. In the said embodiment, the battery (10) which is located at the closest end to the direct current-alternating current inverter (8) among the interconnected batteries (10), is connected to the direct current-alternating current inverter (8) whereas the battery (10) which is located at the other end is connected to the photovoltaic panel (4) electrically.

In practice of the described embodiment of the invention comprising four frames (7) independent of each other, the batteries (10) are placed into the chambers (6) which are located in the frames (7) wherein there is no direct current-alternating current inverter (8).

By means of the charge control circuit (11), the inverter (8), and the battery (10) which are placed into the frame (7) of the photovoltaic panel (4) in the AC solar panel system (1), the solar panel system (1) only with the inverter (8) or both the charge control circuit (11) and the inverter (8) is ready for use of end user.

It is possible to develop various embodiments of the inventive “AC solar pane system (1)”, it cannot be limited to examples disclosed herein and it is essentially according to claims.

1.-9. (canceled)

10. An AC solar panel system (1) comprising:
at least one photovoltaic panel (4) having a plurality of cells (2) that converts energy of solar rays into direct current electricity and at least one connector (3) that enables the current to go out on thereof;
at least one frame (7) which encloses the photovoltaic panel (4), the frame having a channel (5) that enables the photovoltaic panel (4) to be held safely at a surface thereof facing the photovoltaic panel (4), and the frame having an empty chamber (6) inside;
and characterized by
at least one direct current-alternating current inverter (8) which is placed into the chamber (6) that is provided in the frame (7), connected to the connector (3) and converts the direct current that is received from the connector (3) into alternating current.

11. The AC solar panel system (1) according to claim 10, characterized by at least one plug (9) associated with the direct current-alternating current inverter (8) which enables the alternating current that is formed by the direct current-alternating current inverter (8) to be fed to systems outside the panel (1).

12. The AC solar panel system (1) according to claim 10, characterized by the channel (5) having a C form which is located on the frame (7) and in which the photovoltaic panel (4) is placed.

13. The AC solar panel system (1) according to claim 11, characterized by the channel (5) having a C form which is located on the frame (7) and in which the photovoltaic panel (4) is placed.

14. The AC solar panel system (1) according to claim 10, characterized by the photovoltaic panel (4) which has a rectangular shape.

15. The AC solar panel system (1) according to claim 11, characterized by the photovoltaic panel (4) which has a rectangular shape.

16. The AC solar panel system (1) according to claim 12, characterized by the photovoltaic panel (4) which has a rectangular shape.

17. The AC solar panel system (1) according to claims 13, characterized by the photovoltaic panel (4) which has a rectangular shape.

18. The AC solar panel system (1) according to claims 10, characterized by four frames (7) independent of each other which are identical in form and enable to hold the photovoltaic panel (4) from each edge thereof safely.

19. The AC solar panel system (1) according to claim 11, characterized by four frames (7) independent of each other which are identical in form and enable to hold the photovoltaic panel (4) from each edge thereof safely.

20. The AC solar panel system (1) according to claim 12, characterized by four frames (7) independent of each other which are identical in form and enable to hold the photovoltaic panel (4) from each edge thereof safely.

21. The AC solar panel system (1) according to claim 13, characterized by four frames (7) independent of each other which are identical in form and enable to hold the photovoltaic panel (4) from each edge thereof safely.

22. The AC solar panel system (1) according to claim 10, characterized by the direct current-alternating current inverter (8) being placed into the chamber (6) which is located in the frame (7) that is closest to the connector (3) provided in the photovoltaic panel (4).

23. The AC solar panel system (1) according to claim 11, characterized by the direct current-alternating current inverter (8) being placed into the chamber (6) which is located in the frame (7) that is closest to the connector (3) provided in the photovoltaic panel (4).

24. The AC solar panel system (1) according to claim 12, characterized by the direct current-alternating current inverter (8) being placed into the chamber (6) which is located in the frame (7) that is closest to the connector (3) provided in the photovoltaic panel (4).

25. The AC solar panel system (1) according to claim 13, characterized by the direct current-alternating current inverter (8) being placed into the chamber (6) which is located in the frame (7) that is closest to the connector (3) provided in the photovoltaic panel (4).

26. The AC solar panel system (1) according to claim 10, characterized by at least one battery (10) which is located in the chamber provided in the frame (7), the at least one battery connected to the direct current-alternating current inverter (8) electrically from one end thereof and to the photovoltaic panel (4) from the other end thereof, and stores the direct current that is generated by the cells (2) in order to feed the systems which are connected to the solar panel system (1) at night or in times when solar rays are insufficient such as during cloudy weather.

27. The AC solar panel system (1) according to claim 26, characterized by at least one charge control member (11) which is placed into the chamber (6) provided in the frame (7) and enables the battery (10) to be charged in a controlled manner by regulating the voltage of the photovoltaic panel (4), and the at least one charge control member connected to the battery (10) electrically from one end thereof.

28. The AC solar panel system (1) according to claim 22, characterized by a plurality of batteries (10) which are connected to each other electrically, a first battery which is located at the closest end to the direct current-alternating current inverter (8) is connected to the direct current-alternating current inverter (8) and a second battery which is located at the other end is connected to the photovoltaic panel (4) electrically.

29. The AC solar panel system (1) according to claim 26, characterized by a plurality of batteries (10) which are connected to each other electrically, a first battery which is located at the closest end to the direct current-alternating current inverter (8) is connected to the direct current-alternating current inverter (8) and a second battery which is located at the other end is connected to the photovoltaic panel (4) electrically.
